(19) United States
(12) Patent Application Publication
(10) Pub. No.: US 2016/0068011 A1
(43) Pub. Date: Mar. 10, 2016

(54) Inlays for Surface Indicia

(71) Applicant: Eldon Royce Bunnell, The Colony, TX (US)

(72) Inventor: Eldon Royce Bunnell, The Colony, TX (US)

(21) Appl. No.: 14/677,093

(22) Filed: Apr. 2, 2015

Related U.S. Application Data
(60) Provisional application No. 61/974,974, filed on Apr. 3, 2014.

(51) Int. Cl. B44C 1/26

(52) U.S. Cl. CPC B44C 1/26

(57) ABSTRACT

The present disclosure defines embodiments of objects having durable markings on the surfaces thereof, the markings created using inlaid materials in desirable patterns. According to certain embodiments, the inlays comprise nested inner and outer inlays.

### CROSS-REFERENCE TO RELATED APPLICATIONS

This application claims priority to United States Provisional Application Ser. No. 61/974,974 filed Apr. 3, 2014.

### TECHNICAL FIELD OF THE DISCLOSURE

The present disclosure relates generally to the field of surface indicia and, more particularly, to structures and methods for providing useful, durable and decorative surface indicia using inlays.

### BACKGROUND OF THE DISCLOSURE

It is known in the art to create attractive and useful markings on the surfaces of objects using various patterns of inlaid materials. Such materials may include, but are not limited to, woods, metals and polymers. Multiple inlaid materials may be combined in attractive combinations in order to provide maximum versatility in the appearance of the finished object.

### SUMMARY OF THE DISCLOSURE

The present disclosure provides a versatile system for creating attractive and useful surface indicia in a convenient, easy and economical manner. According to one aspect, the present disclosure provides an object comprising a body having an outer surface having a cavity disposed therein. At least a first inlay is disposed in the cavity disposed in the outer surface. The first inlay comprises an inner surface, an outer surface, and an array of edge surfaces extending from the inner surface to the outer surface.

According to a second aspect, the present disclosure relates to an inlay assembly for a surface comprising a first inlay and a second inlay. The first inlay comprises an inner surface, an outer surface and an array of edge surfaces extending from the inner surface to the outer surface. The second inlay, disposed at least partly within the first inlay, comprises an inner surface, an outer surface and an array of edge surfaces extending from the inner surface to the outer surface.

According to a third aspect, the present disclosure relates to a method of manufacturing an object. The method comprises forming at least a first cavity in a surface of the object, the cavity being sized and shaped to accept at least one inlay and disposing in the first cavity at least a first inlay. The first inlay comprises an inner surface, an outer surface, and an array of edge surfaces extending from the inner surface to the outer surface.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description of the disclosure along with the accompanying figures in which corresponding numerals in the different figures refer to corresponding parts and in which:

FIG. 1 depicts a three-quarters view of a disassembled two-part cue;

FIGS. 2 and 3 depict oblique detail views of the forearm portion of the cue shown in FIG. 1;

FIGS. 4, 5 and 6 depict oblique detail views of the butt portion of the cue shown in FIG. 1;

FIGS. 7 and 8 depict partial section views of a first embodiment of a cue according to the present disclosure;

FIGS. 9, 10, 11 and 12 depict various views of an ornamented object according to the present disclosure;

FIGS. 13 and 14 depict partial section views of a second embodiment of a cue according to the present disclosure;

FIGS. 15 and 16 depict partial section views of a third embodiment of a cue according to the present disclosure;

FIGS. 17, 18, 19 and 20 are top, side, bottom and end views of one embodiment of an inlay suitable for use in the present disclosure;

FIG. 21 is a flowchart depicting a process for assembling an ornamented object according to the present disclosure;

FIG. 22 depicts an end view of a four-pointed concave inlay;

FIG. 23 is a bottom view of the four-pointed concave inlay of FIG. 22;

FIG. 24 depicts an end view of an elongated four-pointed concave inlay;

FIG. 25 is a bottom view of the elongated four-pointed concave inlay of FIG. 24;

FIG. 26 depicts an end view of a diamond cruciform inlay;

FIG. 27 is a bottom view of the diamond cruciform inlay of FIG. 26;

FIG. 28 depicts an end view of a double diamond inlay assembly;

FIG. 29 is a bottom view of the double diamond inlay assembly of FIG. 28;

FIG. 30 depicts a top view of a complex multilayer inlay pattern;

FIG. 31 depicts a top view of a triple-diamond inlay pattern;

FIG. 32 is an isometric view of the double-diamond inlay assembly of FIGS. 28 and 29; and

FIG. 33 is a side section view of the double-diamond inlay assembly of FIGS. 28, 29 and 32.

### DETAILED DESCRIPTION OF THE DISCLOSURE

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of a billiard cue. The specific embodiments discussed herein are, however, merely illustrative of specific ways to make and use the disclosure and do not limit the scope of the disclosure to any particular type or shape of object.

The present disclosure relates to structures and methods for marking the surface of an object with durable patterns and shapes for utilitarian or ornamental purposes. As noted, the teachings of the present disclosure are described in connection with a billiard cue by way of example, but those of skill in the art will recognize that the teachings of the present disclosure are useful in a wide variety of contexts, and may be employed wherever a durable marking is desired for ornamental or utilitarian purposes.

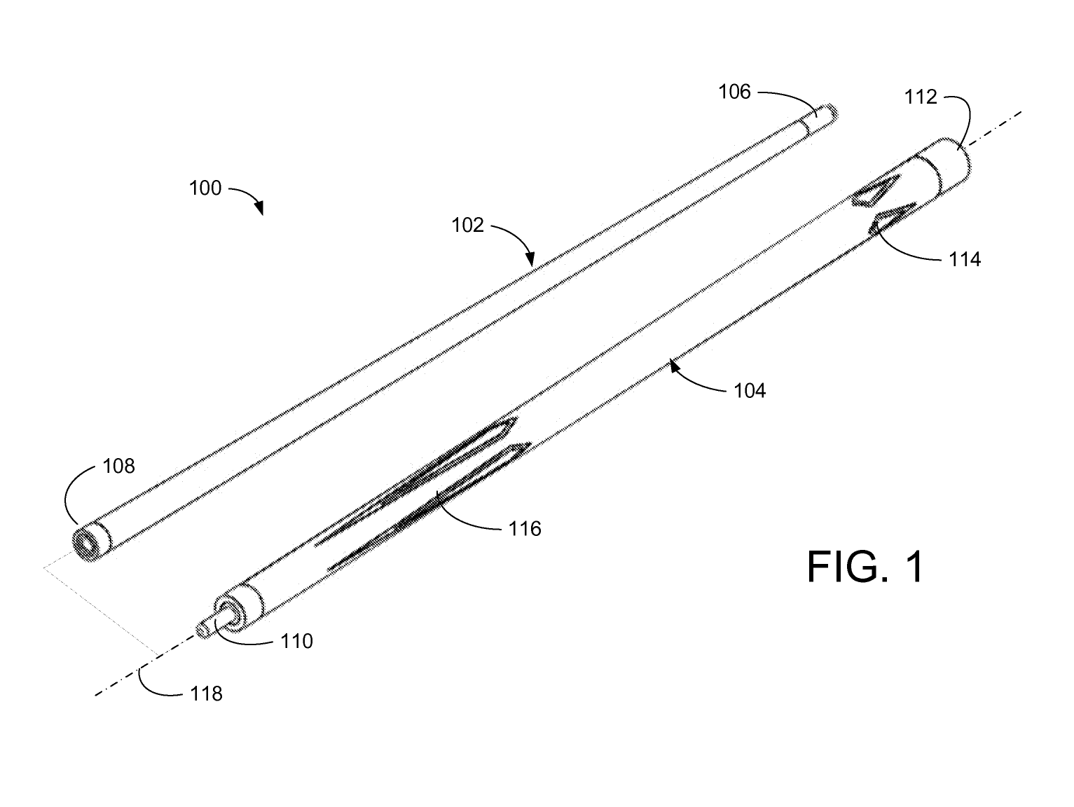

FIG. 1 depicts a three-quarters view of a disassembled two-part cue 100, comprising a shaft 102 and a butt 104. Those of skill in the art will recognize cue 100 as being of the type commonly used in billiard games. A ferrule 106 and threaded joint collar 108 are disposed at first and second ends, respectively, of shaft 102. A threaded joint screw 110 and butt cap 112 are disposed at first and second ends, respectively, of butt 104. Threaded joint collar 108 and threaded joint screw 110 are sized and threaded in a compatible manner, so as to facilitate secure but temporary attachment of shaft 102 to butt 104 via the threaded connection formed therebetween.

Cue 100 incorporates certain visible components designed for identification and distinguishment. An array of butt sleeve inlays 114 is disposed circumferentially about butt 104 proximate to butt cap 112 thereof. A similar array of forearm inlays 116 is disposed circumferentially about butt 104 proximate to threaded joint screw 110. Those of skill in the art will recognize that butt sleeve inlays 114 and forearm inlays 116 are provided by way of example, and that alternate embodiments may incorporate additional or fewer inlays without departing from the spirit and scope of the present disclosure.

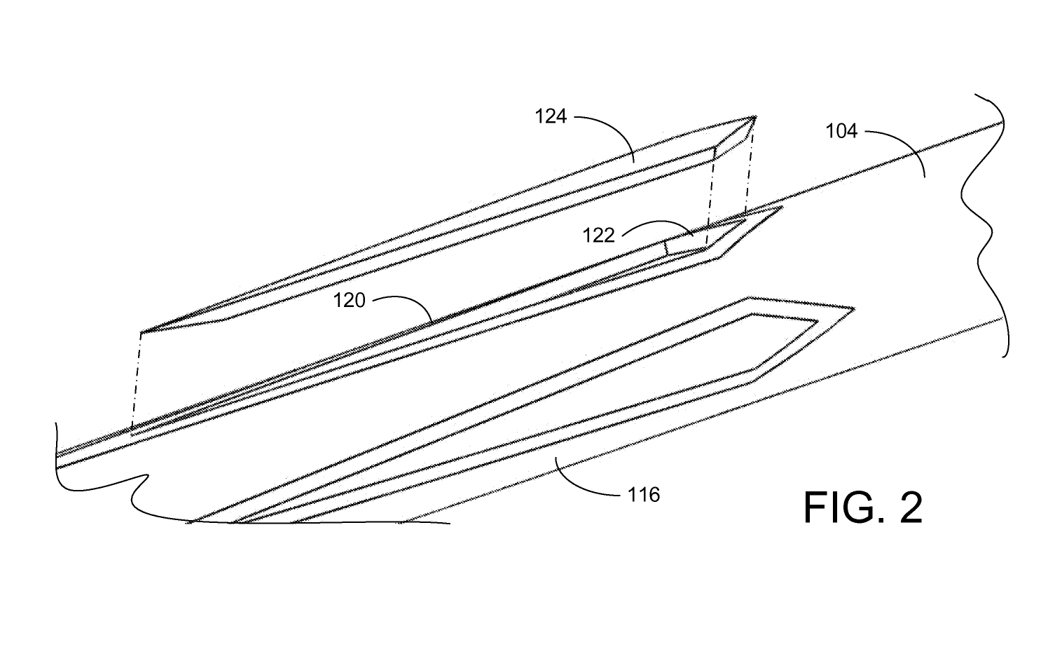

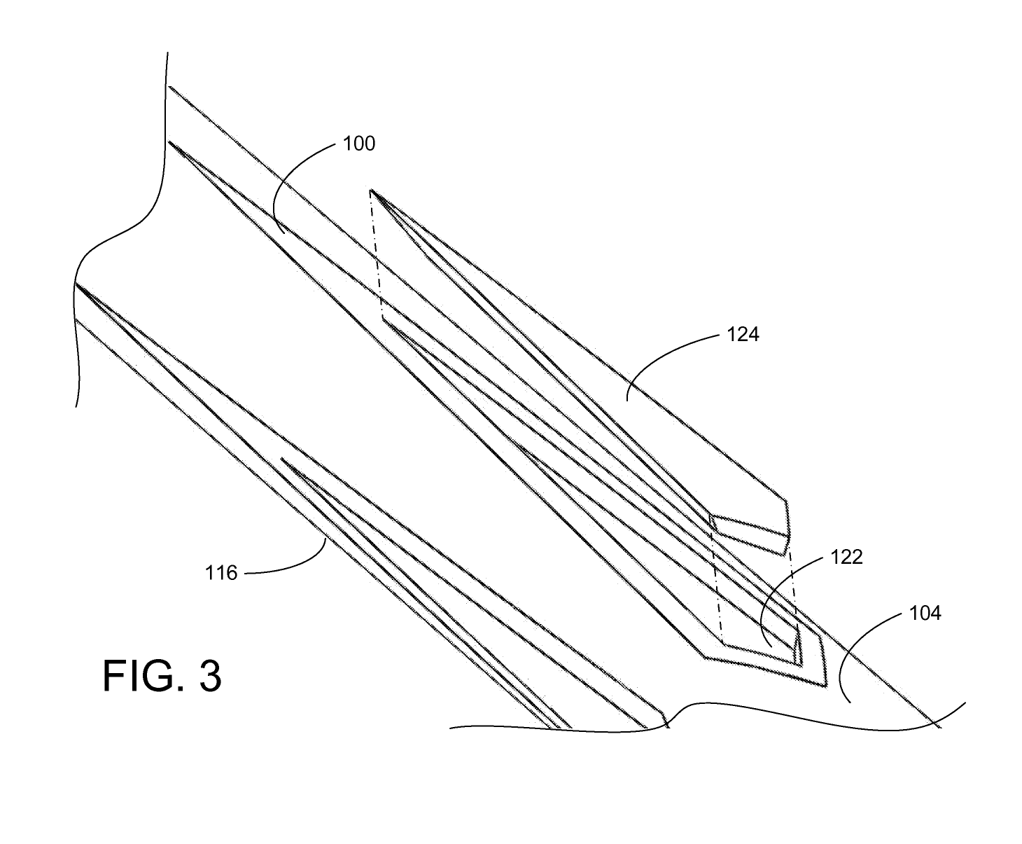

FIGS. 2 and 3 depict oblique detail views of the forearm portion of the butt 104 of cue 100 shown in FIG. 1. As seen in FIGS. 2 and 3, each inlay assembly comprises an outer inlay 120 disposed in a cavity formed within butt 104. The inner surface of outer inlay 120 forms a second cavity 122 sized and shaped to mate with inner inlay 124. Inlays 120 and 124 may be comprised of any material or combination of materials suitable for use as inlays.

The geometry and contours of inlays 120 and 124 may vary depending on the appearance desired. Inlays 120 and 124 are shown as having an elongated quadrilateral shape, but those of skill in the art will recognize that there is nothing within the spirit and scope of the present disclosure limiting the teachings herein to such a shape. As an example, alternate embodiments may comprise arcuate geometry, which may be convex, concave or some combination thereof along the surface of butt 104. In certain embodiments, at least a portion of the points or corners of inlays 120 and 124 meet at sharp, acute or non-rounded points, with no radius, facet or other intermediate surface disposed therebetween. In alternate embodiments, certain of the points or corners may be radiused, faceted, or have some other types of transition surfaces interposed between the major edge surfaces.

Inlays 120 and 124 may have a uniform appearance, or may have patterns or non-patterned variations disposed therein. Inlays 120 and 124 could, in certain embodiments, incorporate materials which do not have a fixed appearance, such as materials whose appearance may vary based on ambient conditions such as light or temperature. Inner inlays 124 are shown as being completely encircled by outer inlays 120, but those of skill in the art will recognize that alternate embodiments may incorporate inlays 120, 124 which are only partially disposed within one another. All of these variations are encompassed within the spirit and scope of the present disclosure.

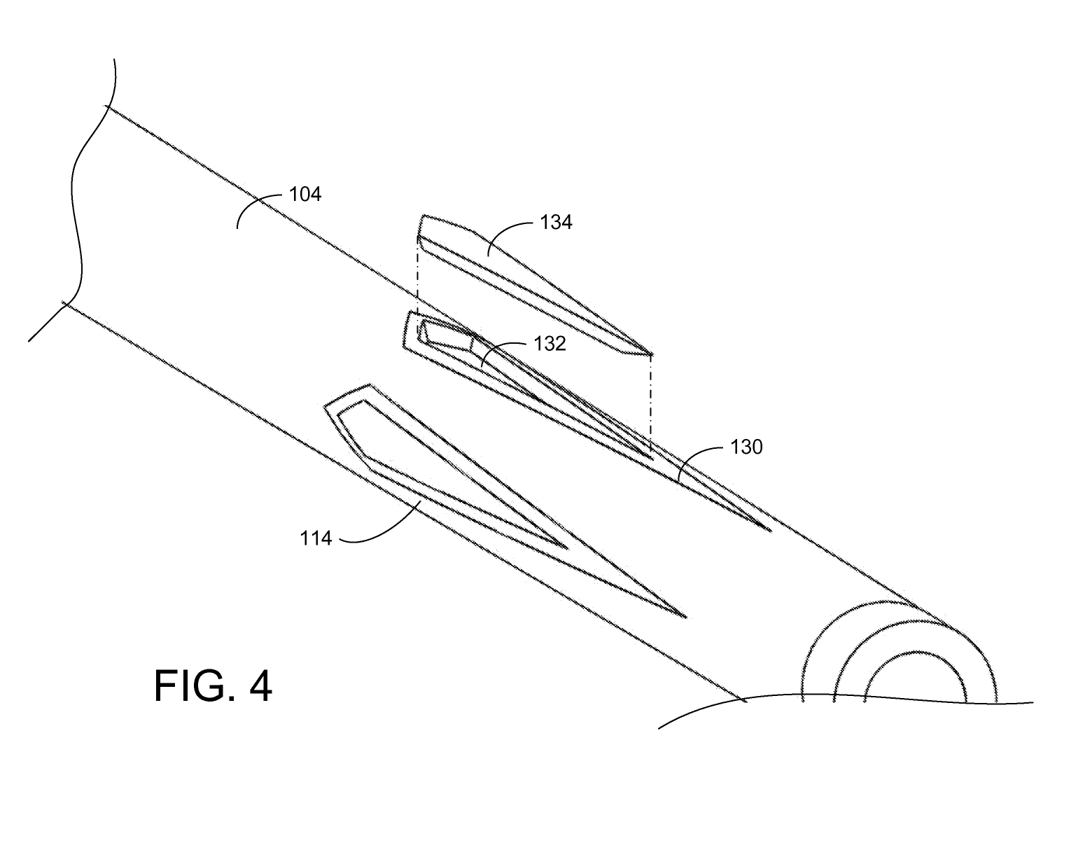

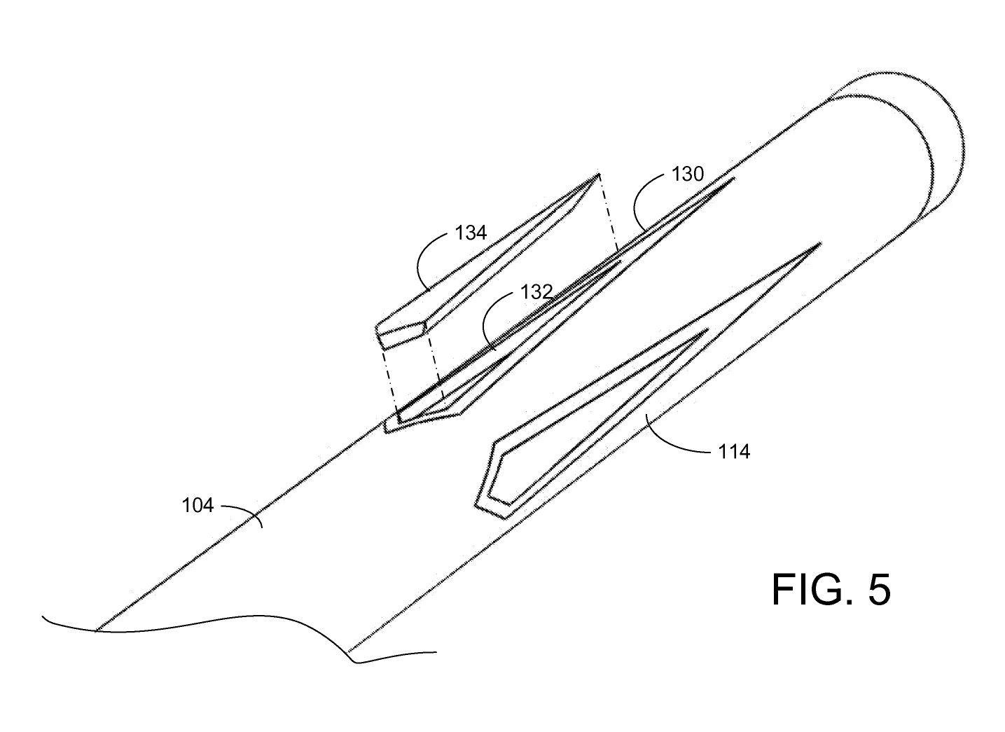

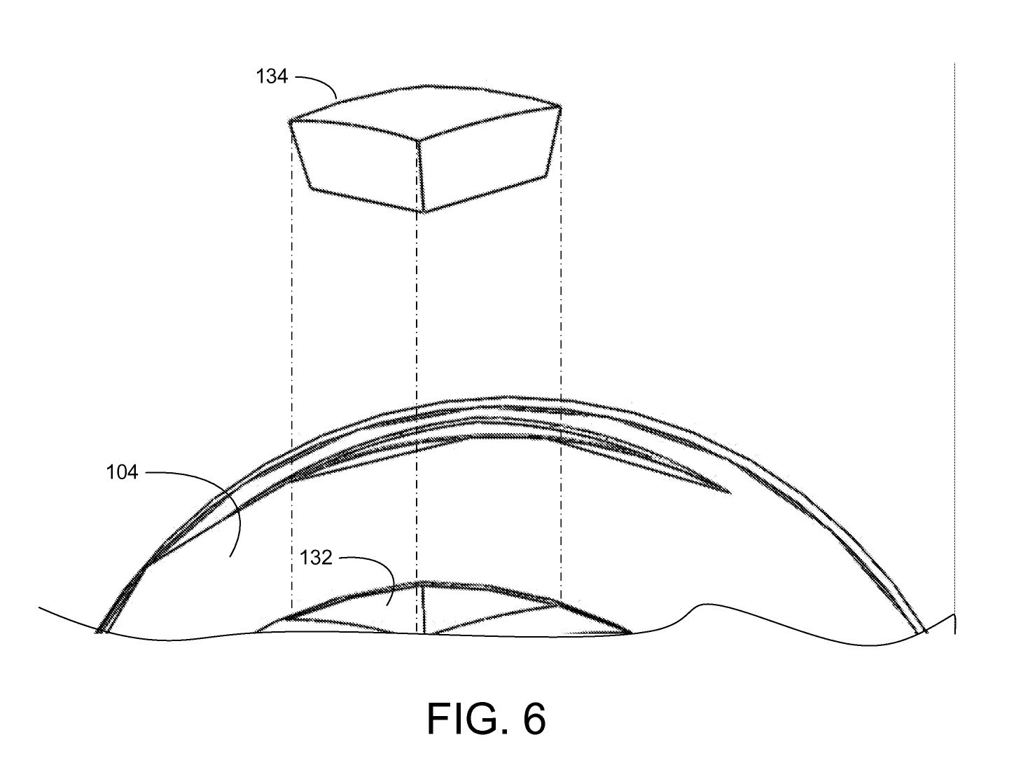

FIGS. 4, 5 and 6 depict oblique detail views of the butt sleeve portion of the butt 104 of cue 100 shown in FIG. 1. The description above with respect to forearm inlays 120 and 124 applies generally to butt sleeve inlays 130 and 134. As above, each inlay assembly comprises an outer inlay 130 disposed in a cavity formed within butt 104. The inner surface of outer inlay 130 forms a second cavity 132 sized and shaped to mate with inner inlay 134.

Inlays 130 and 134 may be comprised of any material or combination of materials suitable for use as inlays, and may have whatever size, shape and contour may be suitable for creating the desired appearance, including but not limited to straight, arcuate, convex or concave geometry. They may be formed of material having a uniform appearance, a patterned appearance, a random appearance or some combination thereof. All of the variations described above in connection with inlays 120, 124 apply to inlays 130, 134.

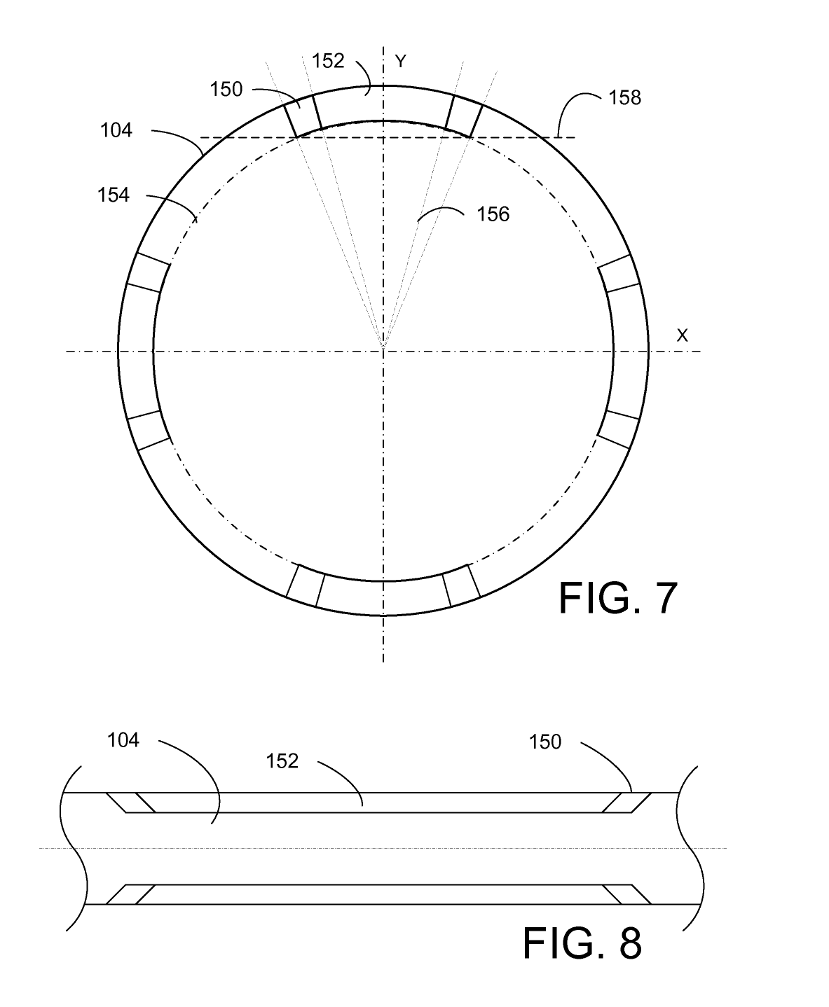

FIGS. 7 and 8 depict partial section views of a first embodiment of inlays disposed in the butt 104 of cue 100 according to the present disclosure. An array of outer inlays 150 and inner inlays 152 are disposed in a regular pattern circumferentially about the surface of butt 104. The inlays 150, 152 are disposed in cavities or pockets formed within butt 104 and shaped and sized to conform to the contours of inlays 150, 152. In the embodiment shown in FIGS. 7 and 8, a cylindrical or conical surface 154 defines the bottom of the inlay cavities, while the edges of the cavities are defined by a series of planes such as plane 156. In certain embodiments, some or all of these planes may intersect longitudinal planes X and Y along the principal longitudinal axis of butt 104. In alternate embodiments, these planes may intersect along various axes. A second plane 158 runs parallel to longitudinal plane X at the inner edges of outer inlay 150.

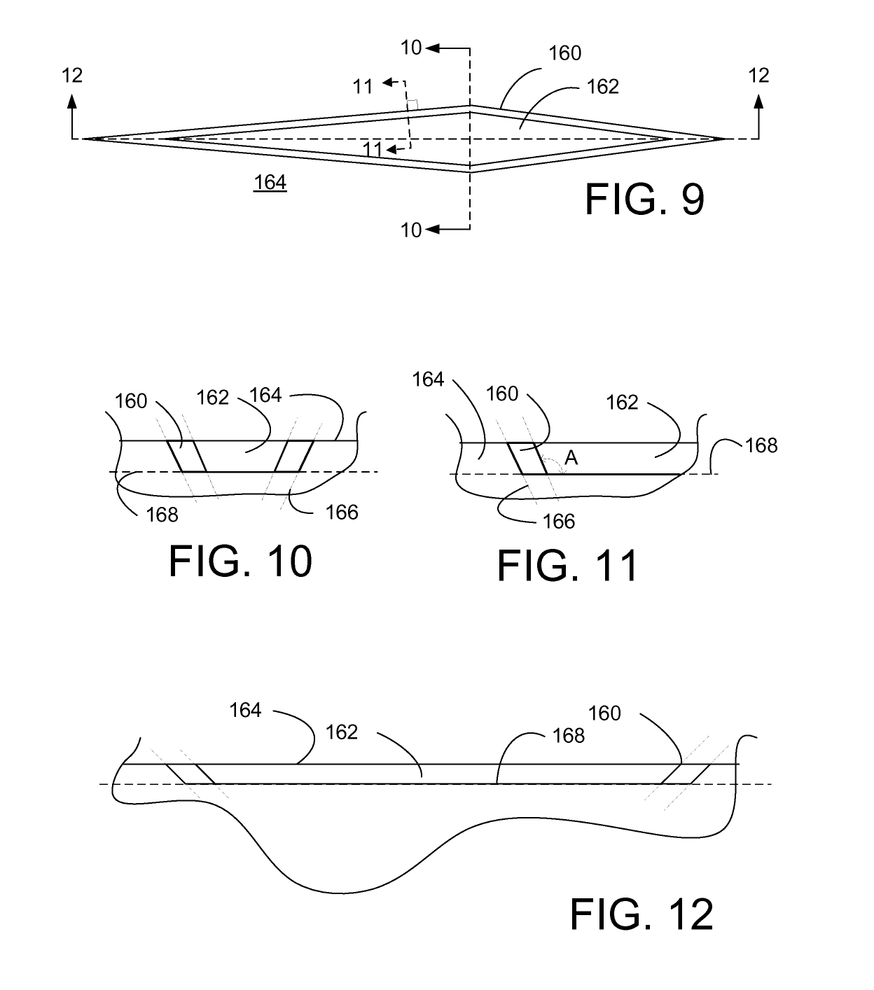

FIGS. 9, 10, 11 and 12 depict various views of an embodiment of inlays disposed in an object according to the present disclosure. FIG. 9 depicts a top view along an axis normal to the surface of the object, while FIG. 10 depicts a cross-section along a plane extending along a minor axis of the inlays. FIG. 11 depicts a cross-section through a plane extending orthogonally from an edge of an inlay. FIG. 12 depicts a cross-section along a plane extending along the principal axis of the inlays.

As seen in FIGS. 9-12, an outer inlay 160 and inner inlay 162 are disposed in a surface 164. Surface 164 is shown as being generally planar for simplicity, but there is nothing within the spirit and scope of the present disclosure limiting surface 164 to a planar profile. The teachings of the present disclosure are not limited to surfaces having any particular shape or profile. In alternate embodiments, surface 164 may be convex or concave, may have a faceted profile, or may employ some combination of faceted, planar and curved surfaces. In particular, surface 164 may be a cylindrical or conical surface, such as the conical surface of butt 104.

As seen in FIGS. 9-12, the inlays 160, 162 are disposed in cavities or pockets formed within surface 164 and shaped and sized to conform to the contours of inlays 160, 162. A set of vectors 166 define the edges of inlays 160, 162 at various points. In the embodiment shown in FIGS. 9-12, the angle between the plane 168 aligned to the bottom of inlays 160, 162 and the vector defining the intersection of the edge of inlay 162 and a plane orthogonal to the edge is identified as angle A. In certain embodiments, angle A may be a common angle for all edges of inlays 160, 162. In other embodiments, angle

A may be shared in common with certain edges, but not others. In other embodiments, the angles may vary from one edge to another, with no edges sharing common angles.

According to certain embodiments, a majority or plurality of the edge surface, by length, may be disposed at a common angle to a shared surface, axis or plane. According to certain embodiments, adjacent edge surfaces may be disposed at a common angle to a shared surface or plane at one or more intersections, junctions, discontinuities or points, at two or more, at four or more, at all such junctions, or at a majority or plurality thereof. It can be seen in FIGS. 9-12 that the edge surfaces of inlays 160 and 162 intersect at sharp, abrupt corners, with no radiuses, facets or other intermediate surfaces disposed therebetween. In alternate embodiments, certain of the points or corners may be radiused, faceted, or have some other types of transition surfaces interposed between the major edge surfaces. In certain embodiments, the edges of inlays 160, 162 may not be straight along vectors 166. They may, for example, be stepped, convex, concave, faceted, or some combination thereof.

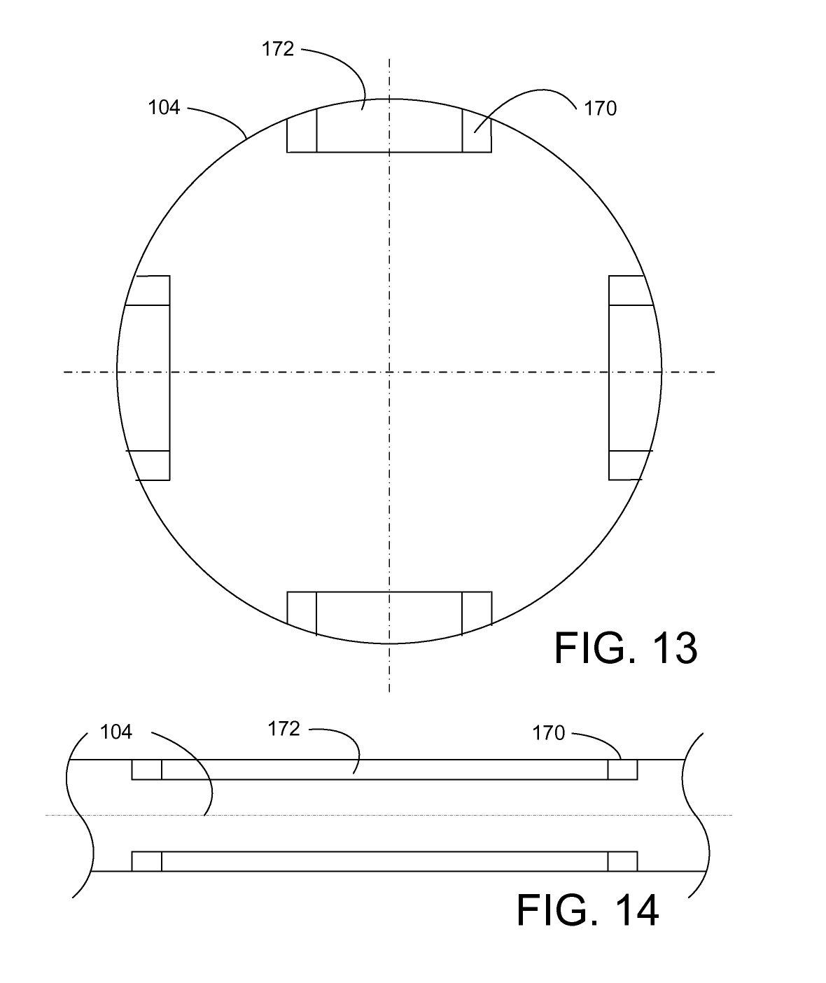

FIGS. 13 and 14 depict partial section views of a third embodiment of inlays disposed in a cylindrical object, such as the butt 104 of cue 100, according to the present disclosure. An array of outer inlays 170 and inner inlays 172 are disposed in a regular pattern circumferentially about the surface of butt 104. The inlays 170, 172 are disposed in cavities or pockets formed within butt 104 and shaped and sized to conform to the contours of inlays 170, 172.

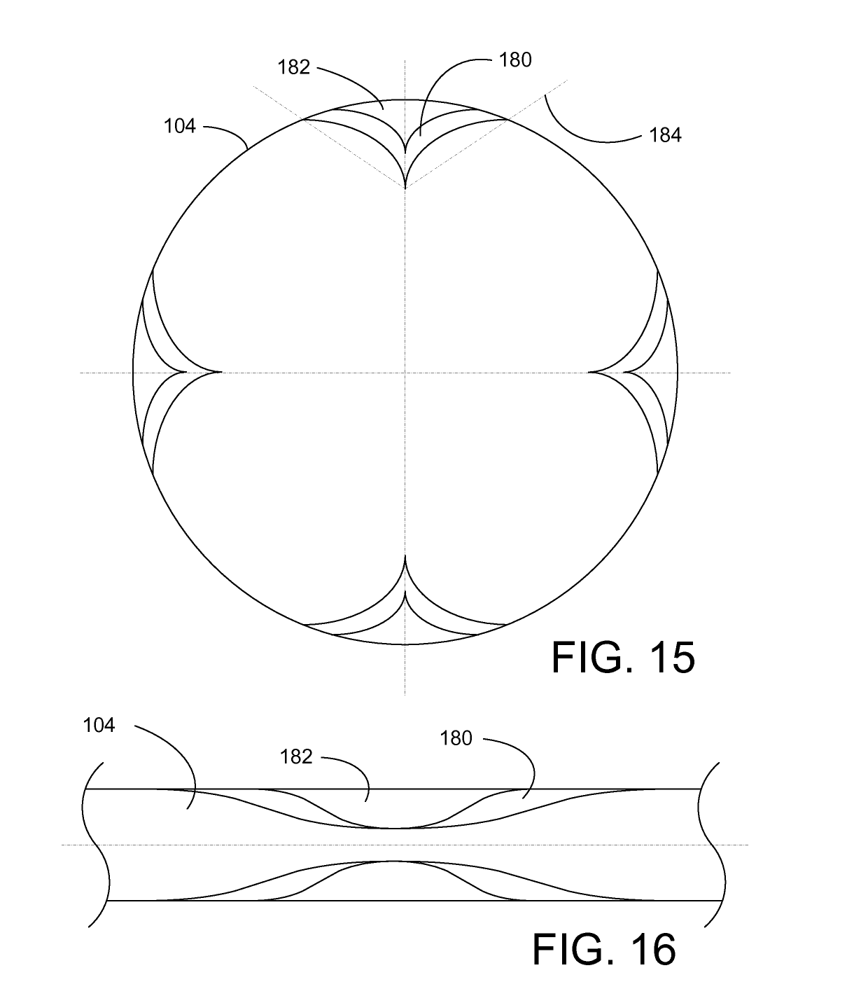

FIGS. 15 and 16 depict partial section views of a fourth embodiment of inlays disposed in the butt 104 of cue 100 according to the present disclosure. An array of outer inlays 180 and inner inlays 182 are disposed in a regular pattern circumferentially about the surface of butt 104. The inlays 180, 182 are disposed in cavities or pockets formed within butt 104 and shaped and sized to conform to the contours of inlays 180, 182. These cavities are generally concave with respect to the outer surface of butt 104 but convex with respect to planes such as planes 184 extending from the surface of butt 104 to the bottom of the inlay cavity.

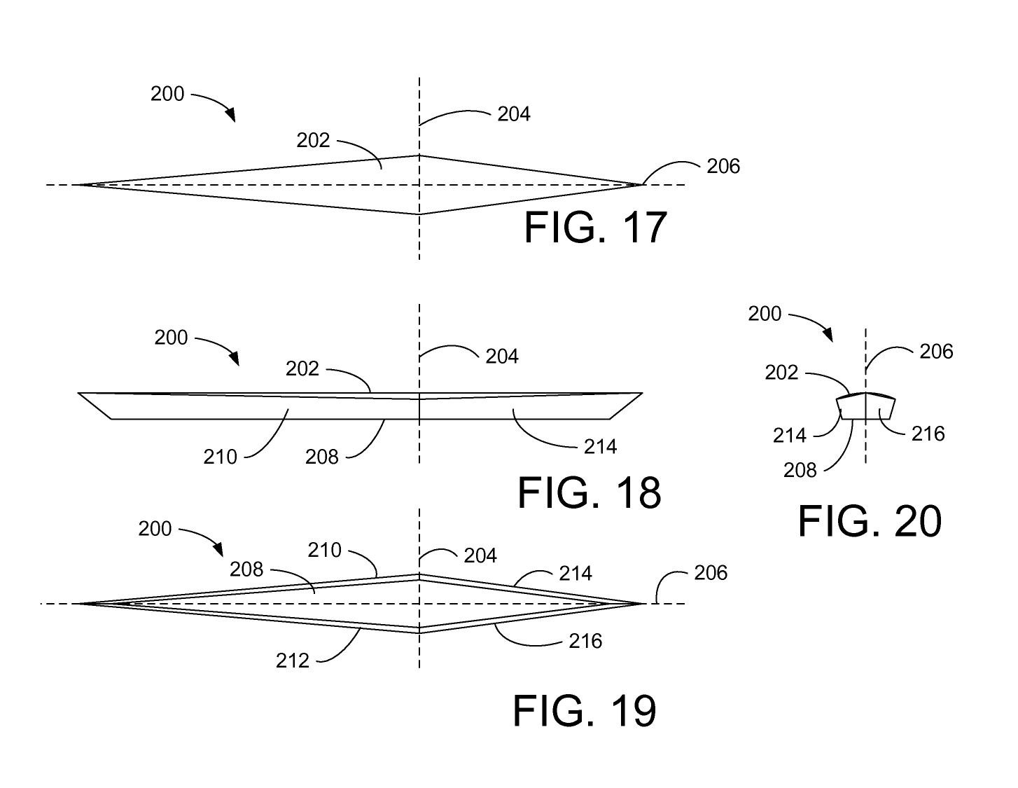

FIGS. 17, 18, 19 and 20 are top, side, bottom and end views of one embodiment of an inlay suitable for use in the present disclosure. Inlay 200 comprises a quadrilateral shape having a curved top surface 202 and a generally-planar bottom surface 208, both intersected by a transverse plane 204 and bisected by a longitudinal plane 206. Top surface 202 and bottom surface 210 are connected by a pair of forward edge surfaces 210, 212 and a pair of rear edge surfaces 214, 216.

In the embodiment shown in FIGS. 17-20, surfaces 208-216 are shown as being generally-planar, but there is nothing within the spirit and scope of the present disclosure restricting these surfaces to such a profile. In alternate embodiments, surfaces 208-216 may be arcuate surfaces being convex from the body of inlay 200, concave therefrom or some combination of both. Similar embellishments, and various combinations thereof, are all comprehended by the present disclosure. It can be seen in FIGS. 17-20 that the edge surfaces 208-216 of inlay 200 meet at sharp points or corners, with no radiuses, facets or other intermediate surfaces disposed therebetween. In alternate embodiments, certain of the points or corners may be radiused, faceted, or have some other types of transition surfaces interposed between edge surfaces 208-216.

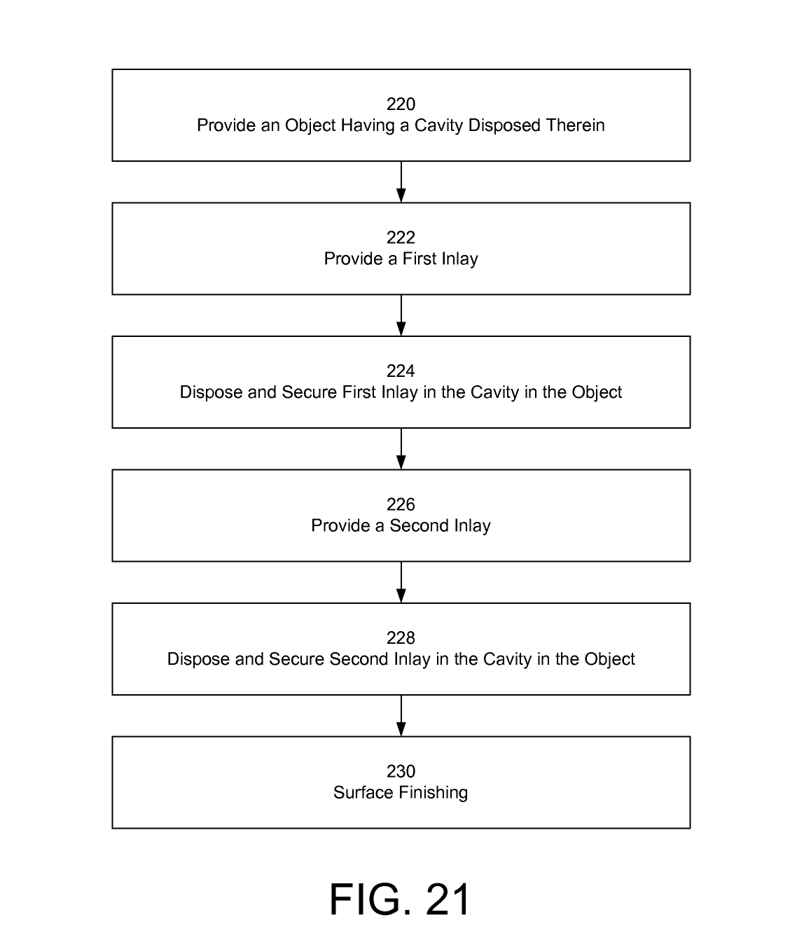

FIG. 21 is a flowchart depicting a process for assembling an ornamented object according to the present disclosure. In step 220, an object is provided having a cavity disposed therein. The cavity may be formed within the body of the object via a molding, casting or extrusion process during the formation of the object body. Alternately, the cavity may be made in a surface of the object after the body of the object is formed, using any number of processes, including cutting, carving, milling, pressing, turning, routing, engraving and punching processes, as examples. The cavity may have any of the shapes and geometrical relationships depicted in the above-described figures, or alternate shapes and geometries, as desired.

Without respect to the manner in which the cavity is made, the cavity is generally shaped and sized to accept at least a portion of the volume of the inlays to be disposed therein. In certain embodiments, it may be highly desirable that the inlays fit tightly within the cavity with little or no gap at the surface, either for appearance or utility purposes. In other embodiments, a tight fit may not be as important. Where a tight fit is important for functional or aesthetic reasons, particular attention to part geometry and manufacturing tolerances may be necessary to ensure such fit.

In step 222, a first inlay is provided, and in step 224, the first inlay is disposed and secured in the cavity in the object. As noted above, the first inlay is to be shaped and sized such that a least a portion of the body of the first inlay fits within the cavity formed in the surface of the object. The inlay may have any of the shapes and geometrical relationships depicted in the above-described figures, or alternate shapes and geometries, as desired. Depending on the embodiment, the first inlay may be secured within the cavity using adhesive, mechanical fasteners, friction, welding or any other suitable means of securement known to those of skill in the art.

In steps 226 and 228, a second inlay is provided and secured within the cavity in the object. In certain embodiments, the second inlay may be disposed partly or completely within the surface boundaries of the first inlay. The second inlay may be secured using any of the methods described above for securement of the first inlay.

In step 230, finishing processes are applied to the surface of the object. The finishing processes will vary depending on the type of surface desired. In certain embodiments, a flat or smooth surface may be desirable, in which case surface milling, flycutting, routing, sanding and polishing processes may be appropriate. In other embodiments, a raised or recessed surface may be desired, in which case cutting, carving, milling, pressing, turning, routing, engraving or punching processes may be appropriate. A coating, paint, sealant or other finish or treatment may be applied after the desired surface contour is achieved, and this finish or treatment may be sanded or polished after curing. These details will be well known to those of skill in the art.

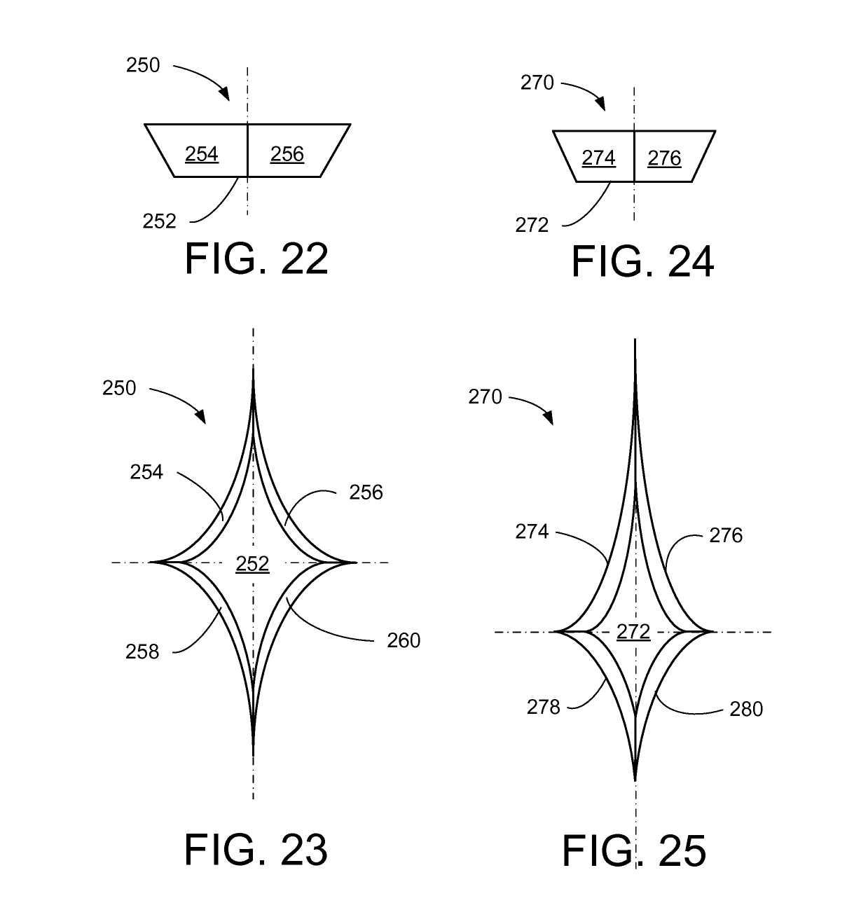

FIG. 22 depicts an end view of a four-pointed concave inlay 250. FIG. 23 is a bottom view of the four-pointed concave inlay 250 of FIG. 22. Inlay 250 comprises a bottom surface 252, left anterior surface 254, right anterior surface 256, left posterior surface 258 and right posterior surface 260. As shown in FIGS. 22 and 23, inlay 250 is symmetrical about its longitudinal and transverse axes. Inlay 250 is shaped and sized to fit tightly within a mating cavity in a pool cue or other object having mating surfaces, as described above. In certain embodiments, inlay 250 may be disposed partly or completely within one or more other inlays having cavities shaped and sized to fit with the surfaces of inlay 250. In certain embodiments, peripheral surfaces 254, 256, 258, 260 may have a common uniform draft angle, such that a vector lying along any of the surfaces will lie at the same angle to surface 252 or a principal normal axis thereto. In certain embodiments, the points of inlay 250 are formed in such a manner as to come to acute, fine, sharp or non-rounded points at the surface, such that adjacent peripheral surfaces converge and meet along an arc or vector with no visually-discernable radius, faceting or other transition surface therebetween.

Although peripheral surfaces 254, 256, 258, 260 are shown as being concave, those of skill in the art will recognize that alternate embodiments may employ planar, convex, faceted or other profiles, and that such profiles would not depart from the spirit and scope of the present disclosure. Further, although bottom surface 252 is shown as being planar, alternate embodiments may employ multiple surfaces or a bottom surface having a non-planar profile.

FIG. 24 depicts an end view of an elongated four-pointed concave inlay 270. FIG. 25 is a bottom view of the elongated four-pointed concave inlay 270 of FIG. 24. Inlay 270 comprises a bottom surface 272, left anterior surface 274, right anterior surface 276, left posterior surface 278 and right posterior surface 280. As shown in FIGS. 24 and 25, inlay 270 is symmetrical about its longitudinal axis, but not along its transverse axis. Inlay 270 is shaped and sized to fit tightly within a mating cavity in a pool cue or other object having mating surfaces, as described above. In certain embodiments, inlay 270 may be disposed partly or completely within one or more other inlays having cavities shaped and sized to fit with the surfaces of inlay 270. In certain embodiments, peripheral surfaces 274, 276, 278, 280 may have a common uniform draft angle, such that a vector lying along any of peripheral surfaces 274, 276, 278, 280 will lie at the same angle to bottom surface 272 or a principal normal axis thereto. In certain embodiments, the points of inlay 270 are formed in such a manner as to come to acute, fine, sharp or non-rounded points at the surface, such that adjacent peripheral surfaces converge and meet along an arc or vector with no visually-discernable radius, faceting or other transition surface therebetween. Although peripheral surfaces 274, 276, 278, 280 are shown as being concave, those of skill in the art will recognize that alternate embodiments may employ planar, convex, faceted or other profiles, and that such profiles would not depart from the spirit and scope of the present disclosure. Further, although bottom surface 272 is shown as being planar, alternate embodiments may employ multiple surfaces or a bottom surface having a non-planar profile.

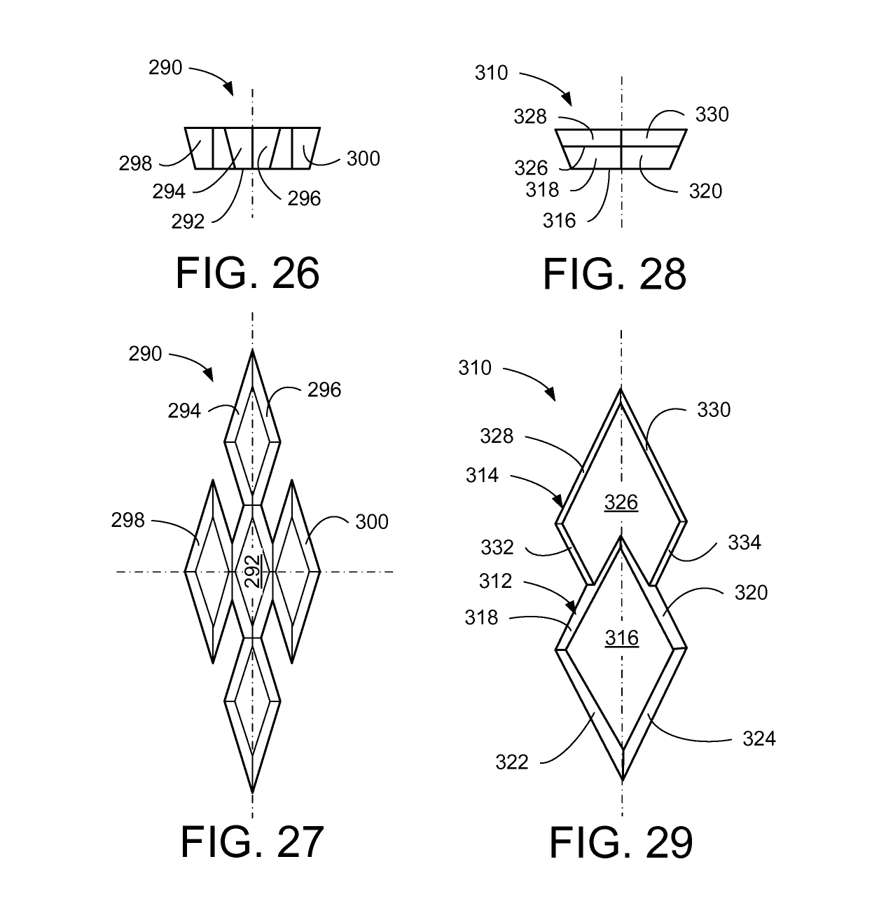

FIG. 26 depicts an end view of a diamond cruciform inlay 290. FIG. 27 is a bottom view of the diamond cruciform inlay 290 of FIG. 26. Inlay 290 comprises a bottom surface 292 surrounded by a series of peripheral surfaces, including left inboard anterior surface 294, right inboard anterior surface 296, left outboard anterior surface 298 and right outboard anterior surface 300. Inlay 290 is shaped and sized to fit tightly within a mating cavity in a pool cue or other object having mating surfaces, as described above. In certain embodiments, inlay 290 may be disposed partly or completely within one or more other inlays having cavities shaped and sized to fit with the surfaces of inlay 290. In certain embodiments, surfaces 294, 296, 298, 300 may have a common uniform draft angle, such that a vector lying along any of the surfaces will lie at the same angle to surface 292 or a principal normal axis thereto. In certain embodiments, the points of inlay 290 are formed in such a manner as to come to acute, fine, sharp or non-rounded points at the surface, such that adjacent peripheral surfaces converge and meet along an arc or vector with no visually-discernable radius, faceting or other transition surface therebetween. Although peripheral surfaces 294, 296, 298, 300 are shown as being planar, those of skill in the art will recognize that alternate embodiments may employ concave, convex, faceted or other profiles, and that such profiles would not depart from the spirit and scope of the present disclosure. Further, although bottom surface 292 is shown as being planar, alternate embodiments may employ a bottom surface having a non-planar profile.

FIG. 28 depicts an end view of a double diamond inlay assembly 310. FIG. 29 is a bottom view of the double diamond inlay assembly 310 of FIG. 28. Inlay assembly 310 comprises a lower diamond inlay 312 having a cavity formed to mate with upper inlay 314.

Lower diamond inlay 312 comprises a lower inlay bottom surface 316 surrounded by lower inlay left anterior surface 318, lower inlay right anterior surface 320, lower inlay left posterior surface 322 and lower inlay right posterior surface 324. Lower diamond inlay 312 is shaped and sized to fit tightly within a mating cavity in a pool cue or other object having mating surfaces, as described above.

In certain embodiments, inlay 312 may be disposed partly or completely within one or more other inlays having cavities shaped and sized to mate with the surfaces of inlay 312. In certain embodiments, peripheral surfaces 318, 320, 322, 324 may have a common uniform draft angle, such that a vector lying along any of the surfaces will lie at the same angle to bottom surface 316 or a principal normal axis thereto. In certain embodiments, the points of inlay 312 are formed in such a manner as to come to acute, fine, sharp or non-rounded points at the surface, such that adjacent peripheral surfaces converge and meet along an arc or vector with no visually-discernable radius, faceting or other transition surface therebetween.

Although peripheral surfaces 318, 320, 322, 324 are shown as being planar, those of skill in the art will recognize that alternate embodiments may employ concave, convex, faceted or other profiles, and that such profiles would not depart from the spirit and scope of the present disclosure. Further, although bottom surface 316 is shown as being planar, alternate embodiments may employ a bottom surface having a non-planar profile.

Upper diamond inlay 314 comprises an upper inlay bottom surface 326 surrounded by upper inlay left anterior surface 328, upper inlay right anterior surface 330, upper inlay left posterior surface 332 and upper inlay right posterior surface 334. Upper diamond inlay 314 is shaped and sized to fit partially within a mating cavity in lower diamond inlay 312 and partially within a mating cavity in a pool cue or other object having mating surfaces, as described above.

In certain embodiments, peripheral surfaces 328, 330, 332, 334 may have a common uniform draft angle, such that a vector lying along any of the surfaces will lie at the same angle to bottom surface 326 or a principal normal axis thereto. In certain embodiments, the points of upper diamond inlay 314 are formed in such a manner as to come to acute, fine, sharp or non-rounded points at the upper surface, such that adjacent peripheral surfaces converge and meet along an arc or vector with no visually-discernable radius, faceting or other transition surface therebetween. Although peripheral surfaces 328, 330, 332, 334 are shown as being planar, those of skill in the art will recognize that alternate embodiments may employ concave, convex, faceted or other profiles, and that such profiles would not depart from the spirit and scope of the present disclosure. Further, although bottom surface 326 is shown as being planar, alternate embodiments may employ a bottom surface having a non-planar profile.

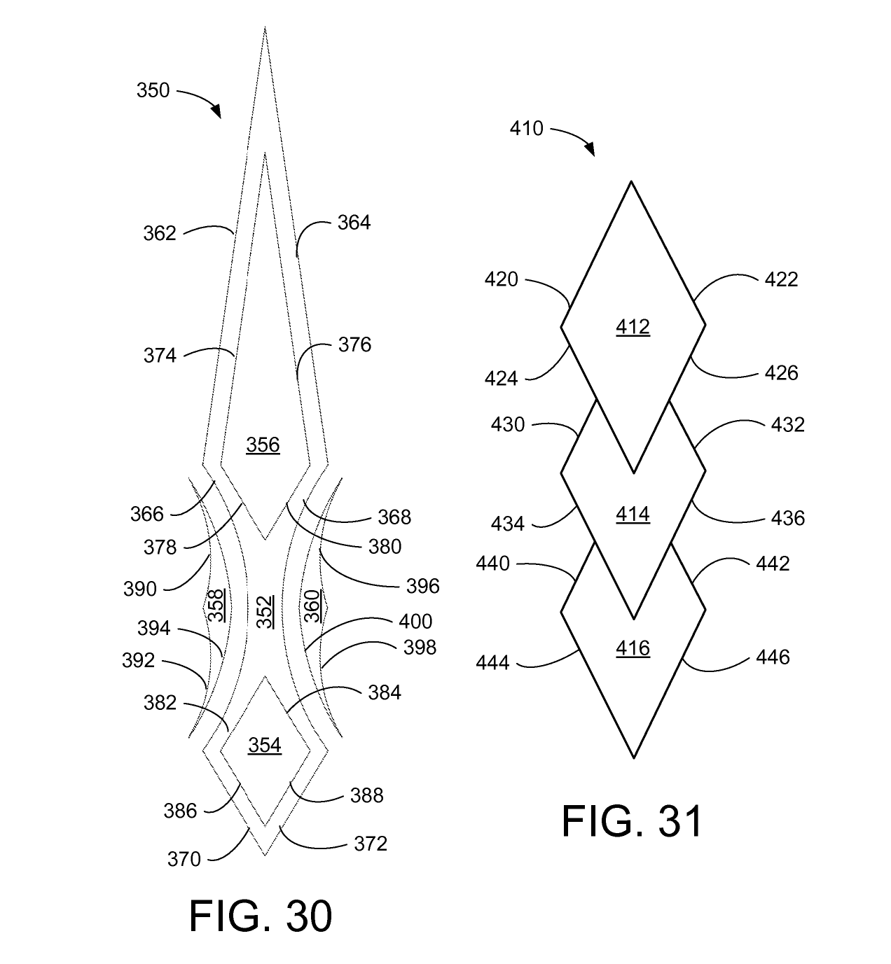

FIG. 30 depicts a top view of a complex multilayer inlay pattern 350. Inlay pattern 350 comprises a lower central inlay 352, posterior upper inlay 354, anterior upper inlay 356, left outboard inlay 358 and right outboard inlay 360. Lower central inlay 352 comprises a left anterior edge 362, right anterior edge 364, left central concave arc 366, right central concave arc 368, left posterior edge 370 and right posterior edge 372. Anterior upper inlay 356 comprises a left anterior edge 374, right anterior edge 376, left posterior edge 378 and right posterior edge 380. Posterior upper inlay 354 comprises a left anterior edge 382, right anterior edge 384, left posterior edge 386 and right posterior edge 388. Left outboard inlay 358 comprises an anterior concave edge 390, posterior concave edge 392 and convex edge 394. Right outboard inlay 360 comprises an anterior concave edge 396, posterior concave edge 398 and convex edge 400.

As set forth above with respect to other inlays previously described, inlays 352, 354, 356, 358, 360 shown in FIG. 30 are shaped and sized to fit within mating cavities in a pool cue or other object having mating surfaces, as decribed above. In certain embodiments, the peripheral surfaces of inlays 352, 354, 356, 358, 360 may have a common uniform draft angle, such that a vector lying along any of the surfaces will lie at the same angle to a common surface or a principal normal axis thereto. In certain embodiments, the points of inlays 352, 354, 356, 358, 360 are formed in such a manner as to come to acute, fine, sharp or non-rounded points at the upper surface, such that adjacent peripheral surfaces converge and meet along an arc or vector with no visually-discernable radius, faceting or other transition surface therebetween. Although the edges of inlays 352, 354, 356, 358, 360 are shown as having certain profiles, those of skill in the art will recognize that alternate embodiments may employ inlay edges and surfaces having any combination of linear, concave, convex, faceted or other profiles, and that such profiles would not depart from the spirit and scope of the present disclosure.

FIG. 31 depicts a top view of a triple-diamond inlay pattern 410. Triple-diamond inlay pattern 410 comprises anterior diamond inlay 412, central diamond inlay 414 and posterior diamond inlay 416. Anterior diamond inlay 412 comprises left anterior edge 420, right anterior edge 422, left posterior edge 424 and right posterior edge 426. Central diamond inlay 414 comprises left anterior edge 430, right anterior edge 432, left posterior edge 434 and right posterior edge 436. Posterior diamond inlay 416 comprises left anterior edge 440, right anterior edge 442, left posterior edge 444 and right posterior edge 446.

As set forth above with respect to other inlays previously described, inlays 412, 414, 416 shown in FIG. 31 are shaped and sized to fit within mating cavities in a pool cue or other object having mating surfaces, as described above. In certain embodiments, the peripheral surfaces of inlays 412, 414, 416 may have a common uniform draft angle, such that a vector lying along any of the surfaces will lie at the same angle to a common surface or a principal normal axis thereto. In certain embodiments, the points of inlays 412, 414, 416 are formed in such a manner as to come to acute, fine, sharp or non-rounded points at the upper surface, such that adjacent peripheral surfaces converge and meet along an arc or vector with no visually-discernable radius, faceting or other transition surface therebetween. Although the edges of inlays 412, 414, 416 are shown as having linear profiles, those of skill in the art will recognize that alternate embodiments may employ inlay edges and surfaces having any combination of linear, concave, convex, faceted or other profiles, and that such profiles would not depart from the spirit and scope of the present disclosure.

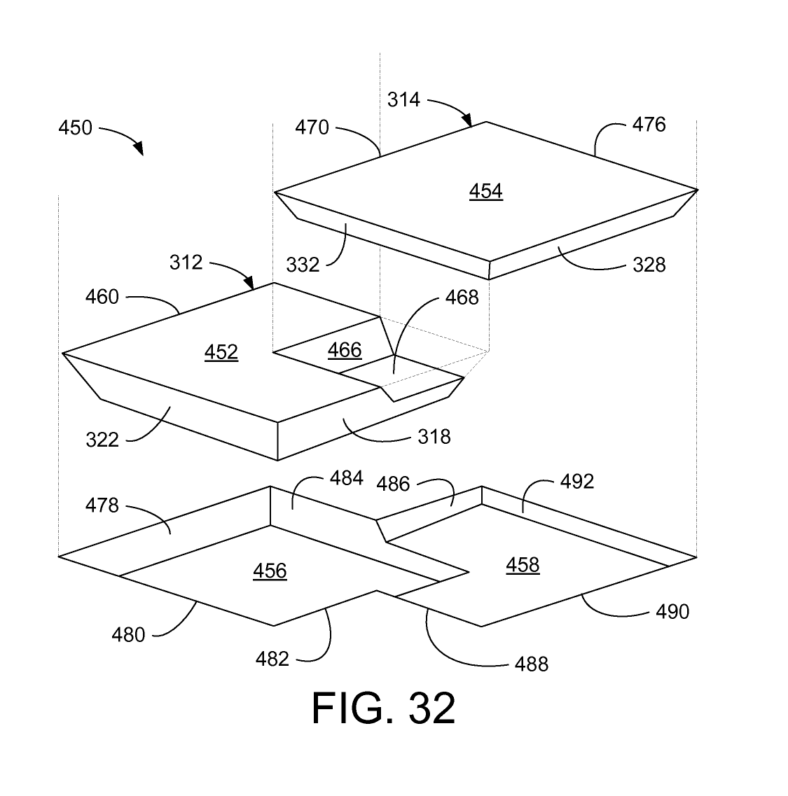

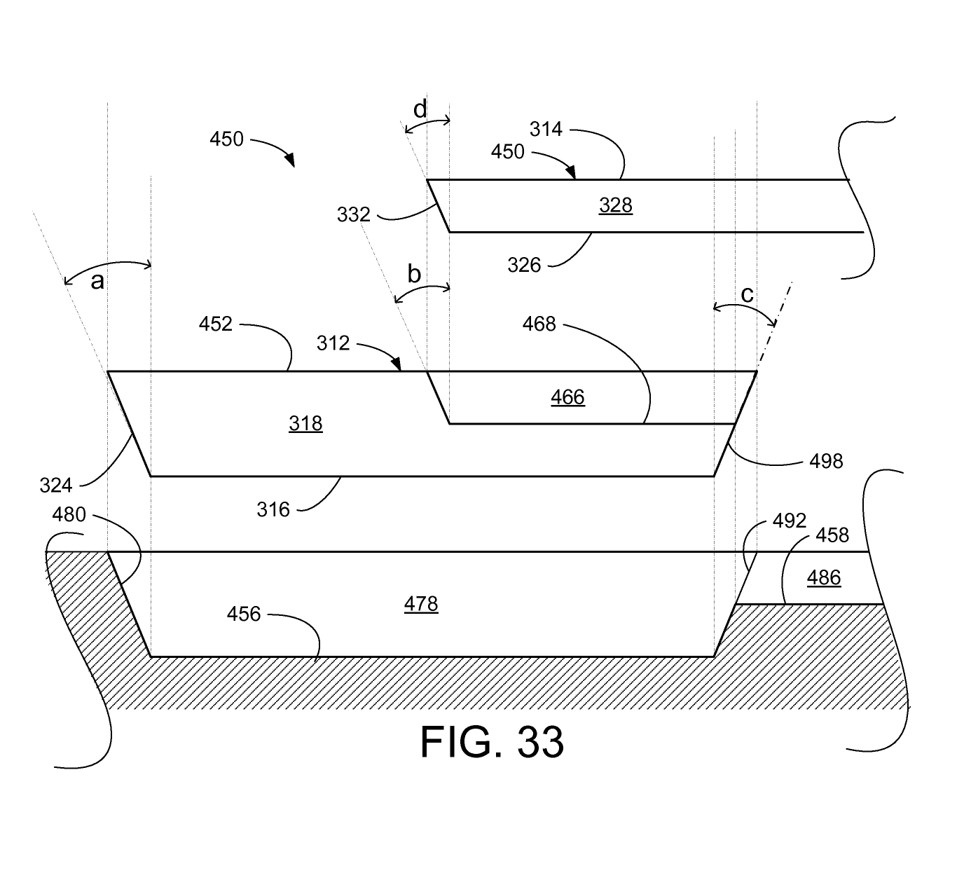

FIG. 32 is an isometric view of an inlay and cavity assembly 450 employing the double-diamond inlay assembly 310 of FIGS. 28 and 29. FIG. 33 is a side section view of the double-diamond inlay and cavity assembly 450 of FIG. 32. Inlay and cavity assembly 450 comprises a lower inlay 312 and upper inlay 314 disposed in a lower cavity 456 and upper cavity 458, respectively.

Lower inlay 312 comprises lower inlay upper right anterior edge 460, lower inlay left anterior surface 318, lower inlay left posterior surface 322, lower inlay pocket left anterior surface 466 and lower inlay pocket bottom surface 468. Upper inlay 314 comprises upper inlay upper right posterior edge 470, upper inlay left anterior surface 328, upper inlay left posterior surface 332 and upper inlay upper right anterior edge 476. Lower cavity 456 comprises lower cavity right posterior surface 478, lower cavity upper left posterior edge 480, lower cavity upper left anterior edge 482 and lower cavity right anterior surface 484. Upper cavity 458 comprises right posterior surface 486, upper cavity upper left posterior edge 488, upper cavity upper left anterior edge 490 and upper cavity upper right anterior surface 492.

All embodiments described herein are presented for purposes of illustration and explanation only. The specific compositions, configurations, orientations and operations of various features, portions and members may be provided in a number of ways in accordance with the present disclosure. As an example, the disclosure depicts straight lines and planar surfaces in certain figures that could, in alternate embodiments, be interchanged with curved, patterned or combination profiles. Conversely, the disclosure depicts smoothly curved lines and surfaces in certain figures that could, in alternate embodiments, be replaced with patterned profiles, straight lines or planar surfaces. In certain embodiments, profiles and surfaces depicted as a single element for simplicity may be replaced by a combination of profiles and surfaces. These variations and others will be well-known to those of skill in the art to which the present disclosure pertains.

Thus, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

What is claimed is:

1. An object comprising:
A body having an outer surface having a cavity disposed therein; and
at least a first inlay disposed in the cavity disposed in the outer surface, the first inlay comprising an inner surface, an outer surface, and an array of edge surfaces extending from the inner surface to the outer surface.

2. An inlay assembly for a surface comprising:
a first inlay comprising an inner surface, an outer surface and an array of edge surfaces extending from the inner surface to the outer surface; and
a second inlay, disposed at least partly within the first inlay, comprising an inner surface, an outer surface and an array of edge surfaces extending from the inner surface to the outer surface.

3. A method of manufacturing an object, the method comprising:
forming at least a first cavity in a surface of the object, the cavity being sized and shaped to accept at least one inlay; and
disposing in the first cavity at least a first inlay, the first inlay comprising an inner surface, an outer surface, and an array of edge surfaces extending from the inner surface to the outer surface.
